(19) United States
(12) Patent Application Publication
(10) Pub. No.: US 2013/0026041 A1
(43) Pub. Date: Jan. 31, 2013

(54) UNIVERSAL ADAPTER WITH MAGNETIC MODULE

(71) Applicant: Sung-Yeol HUH, Seoul (KR)

(72) Inventor: Sung-Yeol HUH, Seoul (KR)

(21) Appl. No.: 13/413,804

(22) Filed: Mar. 7, 2012

(30) Foreign Application Priority Data
Jul. 26, 2011 (KR) 10-2011-0074242

(51) Int. Cl. B03C 5/02

(52) U.S. Cl. 204/661; 204/664

(57) ABSTRACT

Disclosed is a universal adapter including a magnetic module that is coupled between a water pipe and a spray member for spraying tap water regardless of equipped sites of various spray members to produce ionized water. The universal adapter includes: a magnet module including a body having a passage pipe of a nonferrous metal material in an interior thereof and having a plurality of accommodating recesses disposed on opposite sides thereof with respect to the passage pipe, a plurality of permanent magnets accommodated within the accommodating recesses; and a housing including a mounting hole formed in an interior of the housing and through which the magnet module is mounted, a first coupling portion having a screw thread on an outer periphery, and a second coupling portion having a screw thread on an inner periphery.

### BACKGROUND OF THE INVENTION

1. Field of the Invention

The present invention relates to an ionized water producing apparatus for ionizing tap water and, more particularly, to a universal adapter including a magnetic module that is coupled between a water pipe and a spray member for spraying tap water regardless of equipped sites of various spray members to produce ionized water.

2. Description of the Related Art

Water is one of inevitable factors for daily life and vital resource essential for human life.

However, distrust of tap water is getting deeper because tap water contains various impurities and harmful matters for human during the water purification where polluted water produced as civilization is developed is intaken in large scale and is purified at several purification phases. For this reason, it is reality that people mind drinking tap water but either mineral water or purified water from a purifier instead.

Recently, popularized are ionized water producers producing ionized water by ionizing tap water using magnetization of permanent magnets while the ionized water is known useful to human body and is drunken or used for a bath.

The ionized water has a pentagonal or hexagonal ring-shaped molecular structure, wherein the hexagonal ring-shaped water called as ionized water (referred to as “hexagonal water” in Korea) is known as the best water for cells.

Principle of producing ionized water is that permanent magnets are arranged at the upper and lower side of a pipe through which water flows to form a magnetic field such that the magnetic field is formed perpendicular to the direction of the water flow so that surface tension of water is increased and that water is ionized.

The ionized water discharges toxic matters from human body to clean clogged blood vessels, to activate circulation system, to regulate functions of heart, to increase energy of a body, to reduce acidity of internal organs, and to accelerate activity of a brain.

Moreover, shower or bath with the ionized water accelerates blood circulation so that fatigue is relieved, that small water particles clean pores to maintain a smooth skin, that athlete's foot and eczema disappear, that plaque is removed by brushing teeth, and that inflammation is enhanced.

When the ionized water is used in the sink of kitchen, dishes may be washed without detergent and water pollution may be prevented.

However, since the ionized water producers are various in size and type when they are installed in various sites and are high-priced at the same time, costs increase. Further, since they are installed according to the environments of the installation sites, it is difficult to install them.

Furthermore, as shown in FIG. 1, according to the disposition of the permanent magnets mounted to the ionized water producing apparatus, since magnetic fields are created between the pair of permanent magnets 50 having opposite polarities with respect to the passage pipe 40, and the passage pipe 40 as a plurality of permanent magnets 50 are disposed along a lengthwise direction of the passage pipe 40, whereas the permanent magnets 50 disposed along a lengthwise direction of the passage pipe 40 have the same polarity, repulsive forces are generated to offset magnetic forces.

That is, the ionization of tap water due to offset of the magnetic forces of the permanent magnets 50 is reduced.

### SUMMARY OF THE INVENTION

The present invention has been made in view of the above problem, and the present invention provides a universal adapter with a magnet module which is manufactured in a small scale with the magnet module being installed therein and is directly coupled between a spray member and a faucet to produce ionized water without being restricted by the type of the spraying member and the installation site.

The present invention also provides a universal adapter with a magnet module which maximizes ionization of tap water due to opposite polarities of permanent magnets and selectively regulates an amount of discharged ionized water.

In accordance with the aspects of the present invention, there is provided a universal adapter including: a magnet module including a body having a passage pipe of a nonferrous metal material in an interior thereof and having a plurality of accommodating recesses disposed on opposite sides thereof with respect to the passage pipe, a plurality of permanent magnets accommodated within the accommodating recesses such that opposite permanent magnets have opposite polarities with the passage pipe being interposed therebetween and accommodated within the accommodating recesses such that the permanent magnets are disposed adjacent to each other in a lengthwise direction of the body such that the adjacent permanent magnets in the lengthwise direction of the body have opposite polarities, and a pair of metallic shield plates contacting the permanent magnets so as to shield the accommodating plates; and a housing including a mounting hole formed in an interior of the housing and through which the magnet module is mounted, a first coupling portion having a screw thread on an outer periphery thereof such that a water pipe is connected to the housing at a rear side of the mounting hole, and a second coupling portion having a screw thread on an inner periphery thereof such that a spray member for spraying ionized water having passed through the magnet module is connected to the housing.

A flow amount regulator for regulating an amount of injected ionized water produced while water passes through the magnet module may be installed between the first coupling portion and the second coupling portion of the housing.

The flow amount regulator may include: a slipper extending from a front side of the housing toward the first coupling portion and having an outer diameter smaller than an outer diameter of the housing; a passage pad disposed on a front side of the mounting hole and having a communication hole such that ionized water discharged through the magnetic module flows to the second coupling portion; and a flow amount regulating member including a cap-shaped flow amount regulating body rotatably inserted into the slipper of the housing, a regulation hole formed on an upper surface of the flow amount regulating body to be attached to the passage pad so as to varying an opening degree of the communication hole as the flow amount regulating body rotates, and a passage guide surrounding the regulation hole with an upper portion thereof being opened and protruding from an upper surface of the flow amount regulating body to be rotatably coupled to the second coupling portion.

A fixing boss protruding along an outer periphery of the slipper may be formed on the outer periphery of the slipper such that the flow amount regulating body of the flow amount regulating member is rotatably inserted into the slipper, and a fixing hook caught by the fixing boss of the slipper may be formed at an inner distal end of the flow amount regulating body.

A catching boss protruding to the outside may be formed at an upper end of the passage guide such that the flow amount regulating body of the flow amount regulating member is rotatably inserted into the second coupling portion, and a catching recess into which the catching boss may be formed at a position corresponding to a height of the catching boss of the passage guide on an inner periphery of the second coupling portion.

O-rings for maintaining a water-tight state may be respectively interposed between the second coupling portion and the flow amount regulating member and the flow amount regulating member and a front side of the slipper.

A first O-ring accommodating portion in which the O-ring is accommodated may be formed at a front inner side of the slipper and a second O-ring accommodating portion in which the O-ring is accommodated may be formed at an inner lower end of the second coupling portion.

At least one position fixing pin may protrude from a periphery of the passage pad, and a pin hole into which the position fixing pin of the passage pad may be inserted is formed at a front side of the mounting hole.

The communication hole of the passage pad and the regulation hole of the flow amount regulating member may have shapes corresponding to each other.

A plurality of resilient cutaway recesses may be formed on an outer periphery of the flow amount regulating body in a lengthwise direction thereof so as to show resiliency when the flow amount regulating body is mounted around the fixing boss of the slipper.

A knurling may be formed on an upper outer periphery of the flow amount regulating body.

A step communicated with the mounting hole may be formed on an inner side of the first coupling portion of the housing, and a head having an O-ring may be formed at a lower end of the body so as to be press-fitted into the step when the magnetic module is accommodated within the mounting hole.

The body of the magnet module and the housing may be made of one material of ABS, FRP, and an engineering plastic.

According to the universal adapter equipped with the magnet module of the present invention can be coupled to a spray member without being restricted by the type and installation site of the spray member.

### BRIEF DESCRIPTION OF THE DRAWINGS

The objects, features and advantages of the present invention will be more apparent from the following detailed description in conjunction with the accompanying drawings, in which:

FIG. 1 is a reference diagram showing disposition of permanent magnets mounted to an existing ionized water producing apparatus;

FIG. 2 is an exploded perspective view showing a construction of a universal adapter according to the present invention;

FIG. 3 is an exploded perspective view showing a construction of a magnet module of the universal adapter according to the present invention;

FIG. 4 is a sectional view showing a main part of the universal adapter according to the present invention;

FIG. 5 is a reference diagram showing disposition of permanent magnets mounted to the magnet module of the universal adapter according to the present invention; and

FIG. 6 is a reference diagram showing a state where a universal adapter is coupled to a shower according to an embodiment of the present invention.

### DETAILED DESCRIPTION OF EXEMPLARY EMBODIMENTS

Hereinafter, exemplary embodiments of the present invention will be described in more detail with reference to the accompanying drawings. The embodiments and drawings disclosed herein are only to help understanding of the present invention but is not intended to limit the technical scope of the present invention.

A universal adapter equipped with a magnet module of the present invention is connected to a spray member and a water pipe to be used, and is not restricted by an installation site or a type of the spray member when coupled to produce ionized water.

Prior to the description, the spray member is a member, such as a shower, an auxiliary faucet (so called, cobra) for a faucet of a sink, and a spray gun, for spraying tap water, and a universal adapter coupled to a shower will be illustrated as an example in the exemplary embodiments of the present invention.

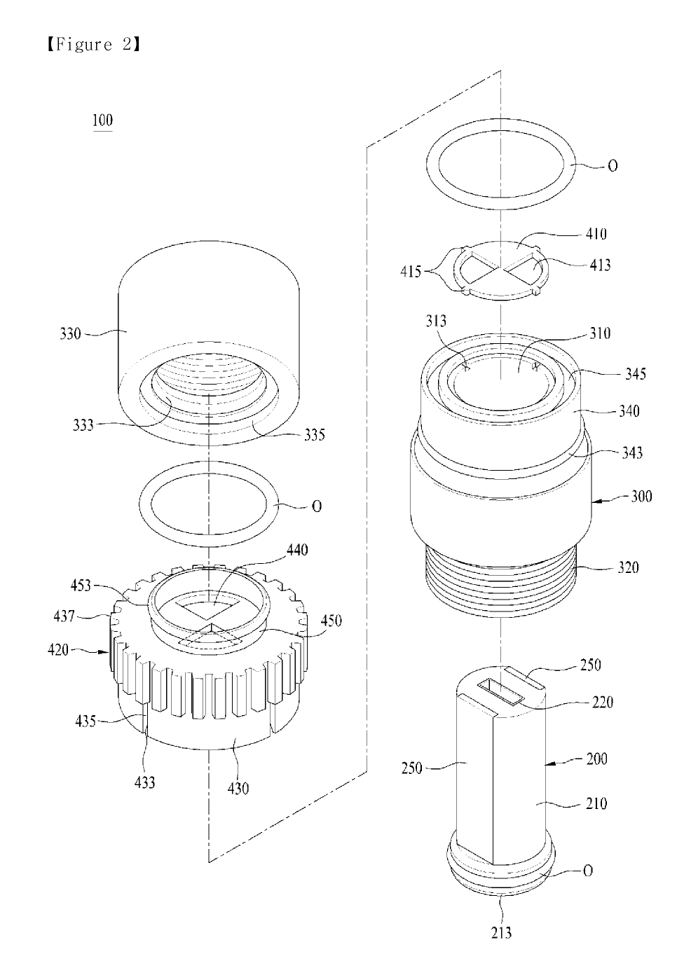

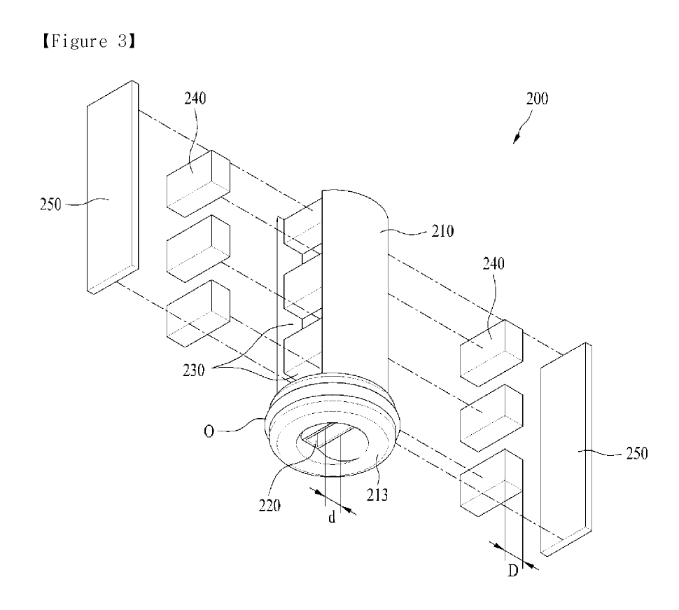

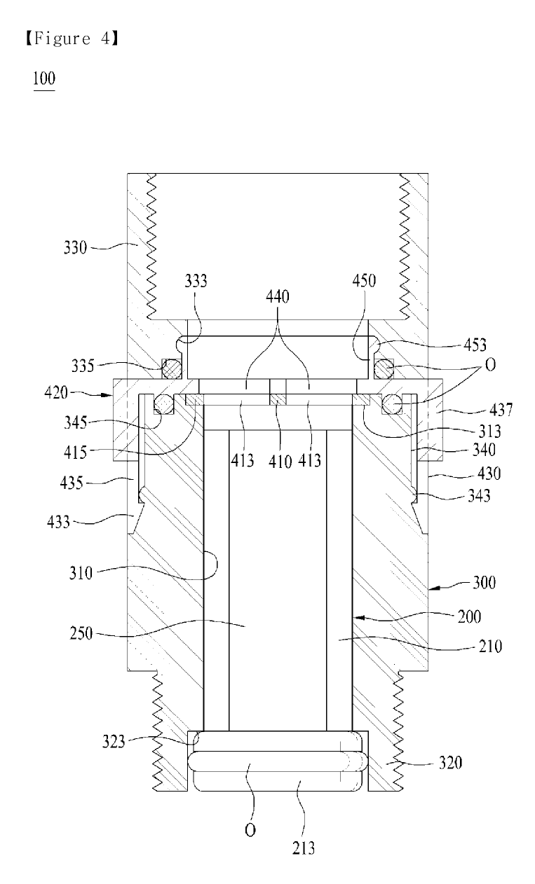

As shown in FIGS. 2 to 6, a universal adapter 100 equipped with a magnetic module 200 includes a magnetic module 200 for producing ionized water, and a housing to which the magnetic module 200 is mounted.

The magnetic module 200 is mounted within the housing 300 to ionize tap introduced water, and includes a body 210 having a passage pipe 220 of a nonferrous metal material in an interior thereof and having a plurality of accommodating recesses 230 disposed on opposite sides thereof with respect to the passage pipe 220, a plurality of permanent magnets 240 accommodated within the accommodating recesses 230 such that opposite permanent magnets 240 have opposite polarities with the passage pipe 220 being interposed therebetween and accommodated within the accommodating recesses 230 such that the permanent magnets 240 are disposed adjacent to each other in a lengthwise direction of the body 210 such that the adjacent permanent magnets 240 in the lengthwise direction of the body 210 have opposite polarities, and a pair of metallic shield plates contacting the permanent magnets 240 so as to shield the accommodating plates 230.

The body 210 has a cylindrical shape corresponding to the mounting hole 310 of the housing 300 to be described below, and includes the passage pipe 220 of a nonferrous metal material having a cross-section corresponding to a square slot-like shape on an inner side thereof.

The passage pipe 220 has a square slot-like shape in order to maintain a contact area larger than surfaces of the permanent magnets 240 accommodated within the accommodating recesses 230 of the body 210 and make magnetic fields created by the permanent magnets 240 uniform, thereby uniformly ionizing tap water flowing through the passage pipe 220.

As the passage pipe 220 is formed of a nonferrous material, it is not influenced by the magnetic fields created by the permanent magnet 240, making it possible to prevent leakage of magnetic fluxes of the permanent magnets 240 and increase magnetic flux density.

Meanwhile, a head 213 having an O-ring O is formed at a lower end of the body 210 so as to be press-fitted into a step 323 formed at an end of the first coupling portion 320 when the magnetic module 200 is accommodated within the mounting hole 310 of the housing 300 to be described below. This is because the magnetic module 200 can remain accommodated within the housing 300 and tap water is prevented from being introduced into the mounting hole 310.

Six accommodating recesses 230 disposed opposite to each other with respect to the passage pipe 220 and having a rectangular shape communicated with the passage pipe 220 respectively are formed on both sides of the body 210.

Here, although six accommodating recesses 230 are illustrated in the drawings, the number of the accommodating recesses 230 may be varied depending on a length of the body 210 and is not limited thereto.

The permanent magnets 240 are accommodated within the accommodating recesses 230.

The permanent magnets 240 are adapted to create magnetic fields within the passage pipe 220 to make water molecules of tap water flowing through the passage pipe 220 particulate and ionize the tap water, and are disposed opposite to each other with respect to the passage pipe 220, the opposite permanent magnets 240 having opposite polarities, when being accommodated within the accommodating recesses 230.

That is, a permanent magnet 240 having an N-S pole and another permanent magnet 240 having an S-N pole are accommodated within the accommodating recesses 230 on opposite sides of the body 210 with the passage pipe 220 being interposed therebetween.

In this way, the opposite permanent magnets 240 are disposed on opposite sides of the passage pipe 220 to create an attractive force due to their opposite polarities while contacting the passage pipe 220.

The permanent magnets 240 disposed opposite to each other and having opposite polarities are disposed in a lengthwise direction of the body 210 with the passage pipe 220 being interposed therebetween within the accommodating recesses formed in a lengthwise direction of the body 210 within the accommodating recesses 230.

In detail, the permanent magnets 240 accommodated within the accommodating recesses 230 respectively are disposed such that they are opposite to each other to have opposite polarities with respect to the passage pipe 220 and also have opposite polarities in a lengthwise direction of the body 210.

In the present exemplary embodiment, since the polarities of the permanent magnets 240 accommodated within the accommodating recesses 230 only have to be different, it is apparent that the directions of the polarities are not limited.

The shield plates 250 are installed on the outsides of the permanent magnets 240 opposite to each other with respect to the passage pipe 220, and are square plates corresponding to the lengths of the permanent magnets 240 according to the number of the permanent magnets 240. The shield plates 250 close the accommodating recesses 230 while contacting the permanent magnets 240.

In this case, the shield plates 250 are preferably formed of a metal material having a dielectric property to contact the permanent magnets 240.

In this way, as the shield plates 250 are disposed opposite to each other with respect to the passage pipe 220 in the body 210 while contacting the permanent magnets 240, lines of magnetic force are created due to attractive forces between the permanent magnets 240 disposed in a lengthwise direction of the body 210 and the permanent magnets 240 opposite to each other with respect to the passage pipe 220 and a magnetic circuit where the lines of magnetic force continuously pass through the shield plates 250.

Thus, as attractive forces are applied in widthwise and lengthwise directions of the passage pipe 220, an existing problem of offsetting magnetic forces can be solved and tap water can be maximally ionized.

Here, differences between the measure values for magnetic flux density due to an existing disposition of permanent magnets 240 and a disposition of permanent magnets 240 according to the present invention will be described. Then, the magnetic flux density of the permanent magnets 240 was 3,300 Gauss and the number of the permanent magnets 240 was four in the present invention and in the related art.

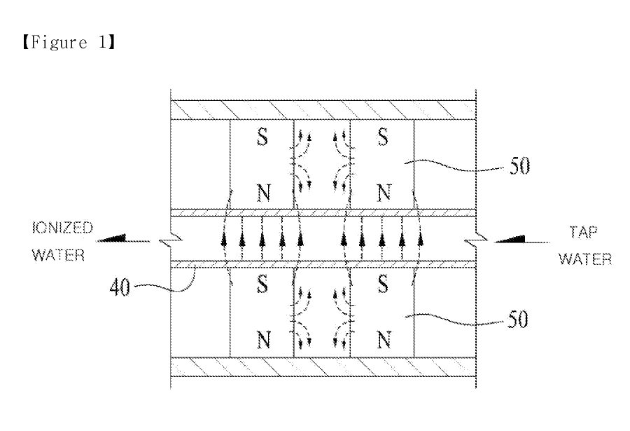

First, as shown in FIG. 1, the existing ionized water producing apparatus according to the related art is configured such that the permanent magnets 240 have opposite polarities with respect to the passage pipe 220 but the permanent magnets 240 disposed in a lengthwise direction of the passage pipe 220 have the same polarity.

In this case, the calculated value for magnetic flux density was 6,600 Gauss and the measured value for magnetic flux density was 6,020 Gauss. This is because magnetic forces are offset and magnetic fluxes are leaked by repulsive forces as the permanent magnets 240 disposed in a lengthwise direction of the passage pipe 220 has the same polarity.

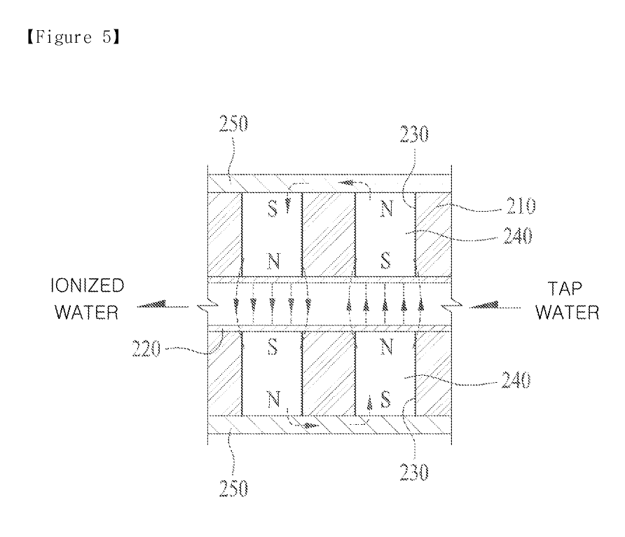

Meanwhile, a disposition of the permanent magnets 240 according to the present invention is as shown in FIG. 5. Here, a disposition of the permanent magnets 240 has been described above, and will be omitted.

According to the present invention, a calculated value for magnetic flux density was 13,200 Gauss, and a measured value for magnetic flux density was 8,700 Gauss. This is because as the permanent magnets 240 disposed in a lengthwise direction of the passage pipe 220 have opposite polarities, leakage of magnetic flux due to the same polarity according to the related art is not produced.

Thus, when the present is compared with the related art, it can be seen that magnetic flux density is increased by 2,680 Gauss according to the present invention, and accordingly tap water can be maximally ionized.

Meanwhile, the thickness D of the permanent magnets 240 is preferably 3 to 6 mm, and the width d of the passage pipe 220 is preferably 1.5 to 3 mm.

When the thickness D of the permanent magnets 240 is less than 3 mm, they cannot be easily machined, whereas when the thickness D of the permanent magnets 240 is more than 6 mm, their volumes become large, causing the volume of the magnetic module 200 to be increased and accordingly increasing manufacturing costs.

When the width d of the passage pipe 220 is less than 1.5 mm, magnetic flux density can be maximized as the distance between the poles of the permanent magnets 240 becomes closer but the supplied tap water cannot flow smoothly relatively, whereas when the width d of the passage pipe 220 is more than 3 mm, the tap water supplied into the passage pipe 220 can flow smoothly but magnetic flux density becomes lower as the distance of the pole of the permanent magnets 240 becomes larger.

Thus, when the thickness D of the permanent magnets 240 is 3 to 6 mm and the width d of the passage pipe 220 is 1.5 to 3 mm, the magnetic flux density of the permanent magnets 240 is maximized.

Next, the housing 300 is coupled between the shower 10 and the water pipe 20 connected to the shower 10 with the magnetic module 200 being installed within the housing 300 so that the flow amount of the ionized water produced by the magnetic module 200 sprayed through the shower 10 can be regulated, and includes a mounting hole 310 formed in an interior of the housing 300 and through which the magnet module 200 is mounted, a first coupling portion 320 having a screw thread on an outer periphery thereof such that a water pipe 20 is connected to the housing 300 at a rear side of the mounting hole 310, and a second coupling portion 330 having a screw thread on an inner periphery thereof such that a spray member for spraying ionized water having passed through the magnet module 200 is connected to the housing 300.

The housing 300 is adapted to accommodate and fix the magnetic module 200, and maintains a cylindrical shape. The circular mounting hole 310 for communicating the housing 300, which corresponds to the shape of the magnetic module 200, is formed in an interior of the housing 300 so that the magnetic module 200 is mounted to the housing 300.

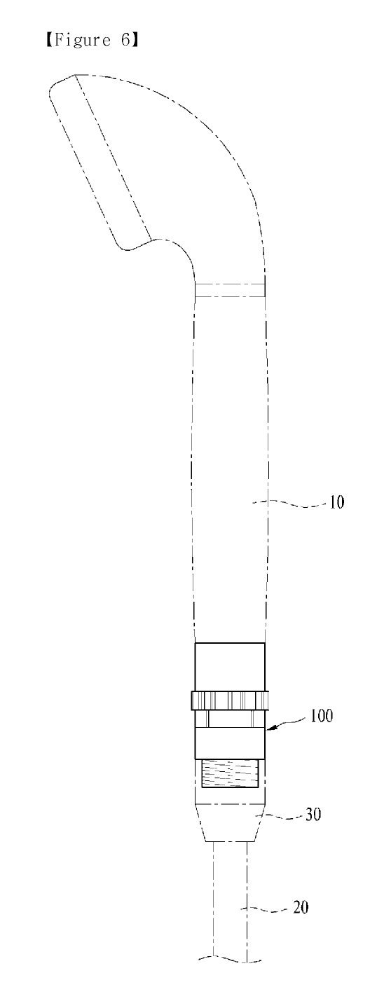

The first coupling portion 320 extends from a rear side of the mounting hole 310, i.e. a rear side of the housing, and a screw thread is formed on an outer periphery of the first coupling portion 320 to be coupled to a coupler 30 of the water pipe 20 branched out from a water supply box (not shown) buried in a building and connected to the shower 10 (see FIG. 6).

A step 323 communicated with the mounting hole 310 is formed at an inner side of the first coupling portion 320 of the housing 300, and this is because it can provide a space for press-fitting a head 213 of the body 210 when the magnetic module 200 is accommodated within the mounting hole 310.

The second coupling portion 330 is formed at a front side of the mounting hole 310, i.e. a front side of the housing 300, and a screw thread is formed at an inner periphery of the second coupling portion 330 to be coupled to a distal end of the shower 10 so that the ionized water produced by the magnetic module 200 mounted to the mounting opening 310 is supplied to the shower 10 (see FIG. 6).

The spray member, such as a shower, an auxiliary faucet (so called, cobra) for a faucet of a sink, and a spray gun, and the water pipe 20 are coupled to each other through screw-coupling by using the coupler 30 installed at an end of the water pipe 20, in which case since male and female screws are employed commonly by means of an international standard, it is apparent that the shapes and the diameters of the first and second coupling portions 320 and 330 are the same in the present exemplary embodiment.

Meanwhile, a flow amount regulator 400 for regulating an amount of sprayed ionized water produced while passing through the magnetic module 200 is preferably installed between the first coupling portion 320 and the second coupling portion 330 of the housing 300.

The flow amount regulator 400 is adapted to selectively regulate an flow amount of the ionized water sprayed to the shower 10, and includes a slipper 340, a passage pad 410, and a flow amount regulating member 420.

The slipper 340 extends from a front side of the housing 300 toward the first coupling portion 320, and has an outer diameter smaller than an outer diameter of the housing 300.

In detail, the slipper 340 is introduced from an outer periphery of the housing 300 toward an interior thereof by a predetermined distance, and has a cylindrical shape corresponding to the shape of the housing 300.

The passage pad 410 has a circular plate-like shape and is disposed at on a front side of the mounting hole 310 formed on an interior of the housing 300. The passage pad 410 has communication holes 413 such that the ionized water discharged through the magnetic module 200 flows to the second coupling portion 330.

As shown in FIG. 2, two communication holes 413 are formed opposite to each other to have a fan-like shape, in which case the shapes of the communication holes 413 preferably correspond to the shapes of regulating holes 440 of the flow amount regulating member 420 to be described below. This is because the flow amount of ionized water can be regulated due to rotation of the flow amount regulating member 420.

Then, at least one position fixing pin 415 protrudes from a periphery of the passage pad 410 and a pin hole 313 into which the position fixing pin 415 of the passage pad 410 is inserted is formed at a front side of the mounting opening 310, wherein although four pins and four pin holes are illustrated in the present exemplary embodiment, their numbers are not limited thereto.

Thus, as the position fixing pins 415 are inserted into the pin holes 313, the passage pad 410 is stably disposed on a front side of the mounting hole 310.

The flow amount regulating member 420 includes a cap-shaped flow amount regulating body 430 rotatably inserted into the slipper 340 of the housing 300, a regulation hole 440 formed on an upper surface of the flow amount regulating body 430 to be attached to the passage pad 410 so as to varying an opening degree of the communication hole 413 as the flow amount regulating body 430 rotates, and a passage guide 450 surrounding the regulation hole 440 with an upper portion thereof being opened and protruding from an upper surface of the flow amount regulating body 430 to be rotatably coupled to the second coupling portion 330.

An interior of the flow amount regulating body 430 is opened such that the slipper 340 of the housing 300 is accommodated therein and is communicated with the outside at the same time, and the flow amount regulating body 430 maintains a cap-like shape corresponding to an outer periphery of the housing 300.

It is preferable that a fixing boss 343 protruding along an outer periphery of the slipper 340 is formed on the outer periphery of the slipper 340 such that the flow amount regulating body 430 of the flow amount regulating member 420 is rotatably inserted into the slipper 430, and a fixing hook 433 caught by the fixing boss 343 of the slipper 340 is formed at an inner distal end of the flow amount regulating body 430.

In this way, as the fixing hook 433 is mounted around the fixing boss 343, the flow amount regulating member 420 can be prevented from being separated from the housing 300 and be rotated.

Although it has been described that the flow amount regulating body 430 is rotatably coupled to the slipper 340 of the housing 300 through coupling the fixing boss 343 and the fixing hook 433, the coupling method is not necessarily limited thereto.

Then, a plurality of resilient cutaway recesses 435 is formed on an outer periphery of the flow amount regulating body 430 in a lengthwise direction thereof so as to show resiliency when the flow amount regulating body 430 is mounted around the fixing boss 343 of the slipper 340, and this is because the fixing hook 433 of the flow amount regulating body 430 can be instantaneously widened outward when mounted around the fixing boss 343 of the slipper 340.

A knurling 437 is further formed on an upper outer periphery of the flow amount regulating body 430 to easily rotate the flow amount regulating member 420, and protrudes to the outside of the flow amount regulating body 430 in the present exemplary embodiment.

The regulation hole 440 is formed on an upper surface of the flow amount regulating body 430 so that the flow amount regulating body 430 is attached to the passage pad 410 when inserted into the slipper 340 of the housing 300 to vary an opening degree of the communication hole 413 as the flow amount regulating body 430 rotates.

Then, the regulation hole 440 preferably has a shape corresponding to the communication hole 413 of the passage pad 410. This is because an flow amount of ionized water can be regulated while the regulation hole 440 and the communication hole 413 overlap each other as the regulation hole 440 rotates together with the flow amount regulating member 420.

The passage guide 450 surrounds the regulation hole 440 with an upper portion thereof being opened, and protrudes from an upper surface of the flow amount regulating body 430 to be rotatably coupled to the second coupling portion 330.

Then, it is preferable that a catching boss 453 protruding to the outside is formed at an upper end of the passage guide 450 such that the flow amount regulating body 430 of the flow amount regulating member 420 is rotatably inserted into the second coupling portion 330, and a catching recess into which the catching boss 453 is formed at a position corresponding to a height of the catching boss 453 of the passage guide 450 on an inner periphery of the second coupling portion 330.

In this way, as the catching boss 453 is inserted into the catching recess 333, the second coupling portion 330 can be prevented from being separated from the flow amount regulating member 420 and be rotated at the same time.

The passage guide 450 guides the ionized water ejected through the regulation hole 440 and the communication hole 413 to the second coupling portion 330.

Although it has been described that the flow amount regulating body 430 is rotatably coupled to the second coupling portion 330 through the coupling of the catching boss 453 and the catching recess 333 in the present exemplary embodiment, the coupling method is not necessarily limited thereto.

Meanwhile, it is preferable that O-rings O for maintaining a water-tight state are respectively interposed between the second coupling portion 330 and the flow amount regulating member 420 and the flow amount regulating member 420 and a front side of the slipper 340.

To this end, it is also preferable that a first O-ring accommodating portion 345 in which the O-ring O is accommodated is formed at a front inner side of the slipper 340 and a second O-ring accommodating portion 335 in which the O-ring O is accommodated is formed at an inner lower end of the second coupling portion 330.

Also, it is preferable that the body 210 of the magnet module 200 and the housing 300 are made of one material of ABS, FRP, and an engineering plastic.

As the above-configured universal adapter 100 is rotatably disposed between the first coupling portion 320 and the second coupling portion 330, a flow amount of the ionized water discharged to the shower 10 can be selectively regulated.

As discussed in detail so far, as the universal adapter 100 equipped with the magnetic module 200 is coupled and used without being restricted by the type of a spraying member, ionized water can be used in a desired site, and can be conveniently used as well since an flow amount of the ionized water can be selectively controlled.

The result of Table 1 was obtained according to the effects of the present invention.

TABLE 1
TEST RESULT

| | | | | TEST METHOD |
|---|---|---|---|---|
| TEST ITEMS | UNIT | SAMPLE | RESULT | PROVIDER |
| STERILIZING TEST | CFU/ | | 6.4 × 10⁵ | CLIENT |
| (E. coli: AT THE | mL | | | |
| BEGINNING) | | | | |
| STERILIZING TEST | CFU/ | | 6.0 × 10⁵ | CLIENT |
| (E. coli: 2 MINUTES | mL | | (6.3%) | |
| LATER) | | | | |
| STERILIZING TEST | CFU/ | | 5.4 × 10⁵ | CLIENT |
| (E. coli: FIVE | mL | | (15.6%) | |
| MINUTES LATER) | | | | |
| STERILIZING TEST | CFU/ | | 8.8 × 10⁵ | CLIENT |
| (S. aureus: AT THE | mL | | | |
| BEGINNING) | | | | |
| STERILIZING TEST | CFU/ | | 9.2 × 10⁵ | CLIENT |
| (S. aureus: 2 | mL | | (—) | |
| MINUTES LATER) | | | | |
| STERILIZING TEST | CFU/ | | 9.1 × 10⁵ | CLIENT |
| (S. aureus: 5 | mL | | (—) | |
| MINUTES LATER) | | | | |

* TEST CONDITION Flow rate (9.6 L/min)
** Reduction rate (%) = {(A − B)/A} × 100 Here, A: the number of germs at the beginning B: the number of germs several minutes later
*** Test strains: Escherichia coli ATCC 25922 Staphyloccus aureus ATCC 6538 Attached: Test result report Purpose: Management of quality

The test report of Table 1 is obtained by Korea Chemical Test Institute.

TABLE 2

TEST RESULT

| | | |
|---|---|---|
| TEST ITEM | SAMPLE 1 | SAMPLE 2 |

STERILIZING RATIO (%): TEST METHOD
SUGGESTED BY CLIENT

| | | |
|---|---|---|
| TEST STRAIN 1 | 0.9 | 0.2 |
| TEST STRAIN 2 | 9.9 | 0.9 |

Note: 1. Test condition
1) Test strainss
i) Staphyloccus aureus ATCC 6538
ii) Escherichia coli ATCC 25922
2) Initial density of germs
i) 1.5 × 10⁵ CFU/mL
ii) 2.3 × 10⁵ CFU/mL
3) Type of sample and amount of collected sample
4) Contact time and condition: 20 minutes, Room Temp.
5) Contrast: Sterilized distilled water
2. Sterilizing ratio (%) = {(A − B)/A} × 100 (A: the number of germs at the beginning, B: the number of germs of the test sample after contact)

The test report of Table 2 is a result value obtained by KATRI Washing/Cleansing Technology Institute Center.

TABLE 3
TEST RESULT

| TEST ITEMS | REFERENCE | RESULT |
|---|---|---|
| GENERAL BACTERIA | LESS THAN 100 | 0 (zero) |
| (CFU/mL) | | |
| FECAL COLIFORMS(/100 mL) | Not detected | Not detected |
| FLUORINE (mg/L) | LESS THAN 1.5 | Not detected |
| SELENIUM (mg/L) | LESS THAN 0.01 | Not detected |
| CYAN (mg/L) | LESS THAN 0.01 | Not detected |
| AMMONIACAL NITROGEN | LESS THAN 0.5 | Not detected |
| (mg/L) | | |
| CADMIUM (mg/L) | LESS THAN 0.005 | Not detected |
| PHENOL (mg/L) | LESS THAN 0.005 | Not detected |
| PARATHION (mg/L) | LESS THAN 0.06 | Not detected |
| CABARYL (mg/L) | LESS THAN 0.07 | Not detected |
| TETRACHLOROETHYLENE | LESS THAN 0.01 | Not detected |
| (mg/L) | | |
| DICHLOROMETHANE (mg/L) | LESS THAN 0.02 | Not detected |
| TOLUENE (mg/L) | LESS THAN 0.7 | Not detected |
| XYLENE (mg/L) | LESS THAN 0.5 | Not detected |
| CARBON TETRACHLORIDE | LESS THAN 0.002 | Not detected |
| (mg/L) | | |
| HARDNESS (mg/L) | LESS THAN 300 | Not 35.5 |
| SMELL | ODORLESS | ODORLESS |
| COPPER (mg/L) | LESS THAN 1 | Not detected |
| DETERGENT (mg/L) | LESS THAN 0.5 | Not detected |
| ZINC (mg/L) | LESS THAN 3 | Not detected |
| NON-VOLATILE RESIDUES | LESS THAN 500 | 73.0 |
| (mg/L) | | |
| MANGANESE (mg/L) | LESS THAN 0.3 | Not detected |
| SULFATE ION (mg/L) | LESS THAN 200 | 8 |
| E-COLIFORM GROUP | Not detected | Not detected |
| (/100 mL) | | |
| LEAD (mg/L) | LESS THAN 0.05 | Not detected |
| ARSENIC (mg/L) | LESS THAN 0.05 | Not detected |
| MERCURY (mg/L) | LESS THAN 0.001 | Not detected |
| 6 VALENT CHROME (mg/L) | LESS THAN 0.05 | Not detected |
| NITRATE NITROGEN (mg/L) | LESS THAN 10 | 1.6 |
| BORN (mg/L) | LESS THAN 1 | Not detected |
| DIAZINON (mg/L) | LESS THAN 0.02 | Not detected |
| FENITROTHION (mg/L) | LESS THAN 0.04 | Not detected |
| 1,1,1-TRI CHLOROETHYLEN | LESS THAN 0.1 | Not detected |
| (mg/L) | | |
| CHLOROETHYLEN (mg/L) | LESS THAN 0.03 | Not detected |
| BENZENE (mg/L) | LESS THAN 0.01 | Not detected |
| ETHYLBENZENE (mg/L) | LESS THAN 0.3 | Not detected |
| 1,1-DICHLOROETHYLENE | LESS THAN 0.03 | Not detected |
| (mg/L) | | |
| 1,2-DICHLOROETHYLENE3- | LESS THAN 0.003 | Not detected |
| CHLOROPROPANE (mg/L) | | |
| CONSUMPTION OF | LESS THAN 10 | 3.28 |
| POTASSIUM PERMANGANATE | | |
| (mg/L) | | |
| TASTE | TASTELESS | TASTELESS |
| CHROMATICITY (DEGREE) | LESS THAN 5 | Not detected |
| HYDROGEN ION | 5.8-8.5 | 7.1 |
| CONCENTRATION | | |
| CHLORIDE ION (mg/L) | LESS THAN 250 | 10 |
| IRON (mg/L) | LESS THAN 0.3 | Not detected |
| TURBIDITY (NTU) | LESS THAN 1 | Not detected |
| ALUMINUM (mg/L) | LESS THAN 0.2 | 0.020 |

| | |
|---|---|
| FINAL RESULT | ALL ITEMS FALL IN REFERENCE |

The test result of Table 3 is a result value obtained by Seoul Health/Environment Institute.

From the test results of Tables 1, 2, and 3, it can be seen that no germ is detected, germ sterilizing effect is excellent, and no colon bacterium is not detected according to the present invention.

The exemplary embodiments of the present invention are provided for the easy description and understanding of the present invention with specific examples but do not limit the scope of the present invention. It will be appreciated by those skilled in the art that various changes and modifications may be practiced without departing from the spirit of the present invention

For example, the type of spray member, the coupling method for the housing 300, the flow amount regulating member 420, and the second coupling portion 330, the number of the accommodating recesses 230 and the permanent magnets 240, the disposition method for the permanent magnets 240 having opposite polarities, the structure of the flow regulator 400, the number of the position fixing pins 415 and the pin holes 313 of the passage pad 410, the shape of the knurling 437, the material of the body 210 of the magnetic module 200 and the housing 300 cannot be the references for determining the technical scope of the present invention, but it is apparent that the technical scope of the present invention is determined only by the attached claims.

What is claimed is:

1. A universal adapter comprising:
a magnet module including a body having a passage pipe of a nonferrous metal material in an interior thereof and having a plurality of accommodating recesses disposed on opposite sides thereof with respect to the passage pipe, a plurality of permanent magnets accommodated within the accommodating recesses such that opposite permanent magnets have opposite polarities with the passage pipe being interposed therebetween and accommodated within the accommodating recesses such that the permanent magnets are disposed adjacent to each other in a lengthwise direction of the body such that the adjacent permanent magnets in the lengthwise direction of the body have opposite polarities, and a pair of metallic shield plates contacting the permanent magnets so as to shield the accommodating plates; and
a housing including a mounting hole formed in an interior of the housing and through which the magnet module is mounted, a first coupling portion having a screw thread on an outer periphery thereof such that a water pipe is connected to the housing at a rear side of the mounting hole, and a second coupling portion having a screw thread on an inner periphery thereof such that a spray member for spraying ionized water having passed through the magnet module is connected to the housing.

2. The universal adapter of claim 1, wherein a flow amount regulator for regulating an amount of injected ionized water produced while water passes through the magnet module is installed between the first coupling portion and the second coupling portion of the housing.

3. The universal adapter of claim 2, wherein the flow amount regulator includes:
a slipper extending from a front side of the housing toward the first coupling portion and having an outer diameter smaller than an outer diameter of the housing;
a passage pad disposed on a front side of the mounting hole and having a communication hole such that ionized water discharged through the magnetic module flows to the second coupling portion; and
a flow amount regulating member including a cap-shaped flow amount regulating body rotatably inserted into the slipper of the housing, a regulation hole formed on an upper surface of the flow amount regulating body to be attached to the passage pad so as to varying an opening degree of the communication hole as the flow amount regulating body rotates, and a passage guide surrounding the regulation hole with an upper portion thereof being opened and protruding from an upper surface of the flow amount regulating body to be rotatably coupled to the second coupling portion.

4. The universal adapter of claim 3, wherein a fixing boss protruding along an outer periphery of the slipper is formed on the outer periphery of the slipper such that the flow amount regulating body of the flow amount regulating member is rotatably inserted into the slipper, and a fixing hook caught by the fixing boss of the slipper is formed at an inner distal end of the flow amount regulating body.

5. The universal adapter of claim 3 or 4, wherein a catching boss protruding to the outside is formed at an upper end of the passage guide such that the flow amount regulating body of the flow amount regulating member is rotatably inserted into the second coupling portion, and a catching recess into which the catching boss is formed at a position corresponding to a height of the catching boss of the passage guide on an inner periphery of the second coupling portion.

6. The universal adapter of claim 5, wherein O-rings for maintaining a water-tight state are respectively interposed between the second coupling portion and the flow amount regulating member and the flow amount regulating member and a front side of the slipper.

7. The universal adapter of claim 6, wherein a first O-ring accommodating portion in which the O-ring is accommodated is formed at a front inner side of the slipper and a second O-ring accommodating portion in which the O-ring is accommodated is formed at an inner lower end of the second coupling portion.

8. The universal adapter of claim 7, wherein at least one position fixing pin protrudes from a periphery of the passage pad, and a pin hole into which the position fixing pin of the passage pad is inserted is formed at a front side of the mounting hole.

9. The universal adapter of claim 8, wherein the communication hole of the passage pad and the regulation hole of the flow amount regulating member have shapes corresponding to each other.

10. The universal adapter of claim 9, wherein a plurality of resilient cutaway recesses is formed on an outer periphery of the flow amount regulating body in a lengthwise direction thereof so as to show resiliency when the flow amount regulating body is mounted around the fixing boss of the slipper.

11. The universal adapter of claim 10, wherein a knurling is formed on an upper outer periphery of the flow amount regulating body.

12. The universal adapter of claim 11, wherein a step communicated with the mounting hole is formed on an inner side of the first coupling portion of the housing, and a head having an O-ring is formed at a lower end of the body so as to be press-fitted into the step when the magnetic module is accommodated within the mounting hole.

13. The universal adapter of claim 12, wherein the body of the magnet module and the housing are made of one material of ABS, FRP, and an engineering plastic.
